(19) United States
(12) Patent Application Publication
(10) Pub. No.: US 2024/0066917 A1
(43) Pub. Date: Feb. 29, 2024

(54) COMPOSITE WHEEL WITH BEAD HUMP HAVING TIRE LOCK GEOMETRY

(71) Applicant: Vision Composite Products LLC, Decatur, AL (US)

(72) Inventors: Alan Arthur Dudley, Decatur, AL (US); Jake Nettie, Decatur, AL (US); John Mathew, Decatur, AL (US)

(21) Appl. No.: 18/237,175

(22) Filed: Aug. 23, 2023

Related U.S. Application Data
(60) Provisional application No. 63/400,274, filed on Aug. 23, 2022.

(51) Int. Cl. B60B 25/00; B60B 5/02; B60B 21/02; B60B 21/10

(52) U.S. Cl. CPC B60B 25/004; B60B 5/02; B60B 21/023; B60B 21/026; B60B 21/102; B60B 2360/3416

(57) ABSTRACT

A composite wheel for use at normal tire pressures as well as at reduced tire pressures may include a spoke section with a mating surface, a barrel section in contact with the spoke section at said mating surface, and a bead hump with tire lock geometry on at least the spoke section. The barrel section may further include a bead hump with the tire lock geometry.

### CROSS REFERENCE TO RELATED APPLICATIONS

This application claims priority to U.S. Provisional Application No. 63/400,274, entitled “COMPOSITE WHEEL WITH BEAD HUMP HAVING TIRE LOCK GEOMETRY” and filed on Aug. 23, 2022, which is incorporated herein by reference in its entirety.

### FIELD OF THE DISCLOSURE

The present disclosure relates to wheels for automobiles and other wheeled vehicles. In particular, the present disclosure relates to a two (2) piece composite carbon fiber wheel with a bead hump having a tire-lock geometry.

### BACKGROUND

As is well known, consumers often desire choices when purchasing an automobile to allow for options based, for example, on looks or durability. With this in mind, the present disclosure provides a novel and unique two (2) piece composite wheel with a tire lock configuration that offers many benefits, including improved tire seating reliability when operated at a low or reduced tire pressure, tire slippage prevention, and reduced wheel weight. More specifically, the present disclosure provides a composite carbon fiber wheel with a tire lock configuration that secures the bead of a tire in the bead seat of a wheel when driving on surfaces where lower tire pressure can be necessary or advantageous and when compressive forces experienced by the tire may otherwise force the tire's bead over the bead hump and into the wheels drop center.

This is not currently possible as carbon fiber wheels are incompatible with the existing bead lock ring design, which engages approximately 30 bolts. Carbon fiber wheels in the prior art cannot be used—for example during certain types of off roading—where bead lock rings are necessary, as carbon fiber wheels are structurally incompatible with the bead lock ring technology. The present disclosure provides a strong and light weight two (2) piece composite carbon fiber wheel that maintains its integrity and durability when used in harsh driving conditions through its tire lock design which negates the need for integrity reducing bolted bead locks.

### BRIEF SUMMARY

In a particular embodiment, a composite two (2) piece molded wheel for use at low tire pressure may comprise a spoke section, a barrel section, and a bead hump with tire lock geometry defined on at least the spoke section. The spoke section may include a mating surface. The barrel section may be in contact with the spoke section at said mating surface.

In an exemplary aspect according to the above-referenced embodiment, said tire lock geometry may comprise a flange including an interior flange surface and a bead seat positioned between the bead hump and flange.

In another exemplary aspect according to the above-referenced embodiment, the bead seat may be angled relative to an interior flange surface of the flange at a first angle of about 92 degrees to about 98 degrees.

In another exemplary aspect according to the above-referenced embodiment, a first transition corner may be defined between the interior flange surface and a bead seat, the first transition corner chamfered with a radius of about four-point-five (4.5) mm.

In another exemplary aspect according to the above-referenced embodiment, the bead hump may include a proximal surface relative to the flange and at least partially facing the interior flange surface.

In another exemplary aspect according to the above-referenced embodiment, a second transition corner may be defined between the proximal surface of the bead hump and the bead seat, the second transition corner chamfered with a radius of about one (1) mm.

In another exemplary aspect according to the above-referenced embodiment, the proximal surface may be angled relative to the bead seat at a second angle, the second angle being between about 85 degrees and about 95 degrees.

In another exemplary aspect according to the above-referenced embodiment, a third transition corner is defined between the proximal surface of the bead hump and a top surface of the bead hump, the third transition corner chamfered with a radius between about zero-point-three (0.3) mm and about zero-point-five (0.5) mm

In another exemplary aspect according to the above-referenced embodiment, a top surface of the bead hump may be perpendicular to the interior flange surface.

In another exemplary aspect according to the above-referenced embodiment, said flange may be taller than the bead hump.

In another exemplary aspect according to the above-referenced embodiment, the flange may be at least fourteen-point-five (14.5) mm tall relative to the bead seat.

In another exemplary aspect according to the above-referenced embodiment, a top surface of the bead hump may be at least zero-point-nine (0.9) mm tall relative to the bead seat.

In another exemplary aspect according to the above-referenced embodiment, a distal surface of the bead hump may be angled relative to a top surface of the bead hump at a third angle greater than or equal to about 15.5 degrees.

In another exemplary aspect according to the above-referenced embodiment, the wheel may comprise a carbon fiber material.

In another exemplary aspect according to the above-referenced embodiment, the wheel may comprise a carbon fiber material with discontinuous fibers.

In another embodiment, a composite two (2) piece wheel for use at low tire pressure may may comprise a spoke section, a barrel section, and a bead hump with tire lock geometry on each of the spoke section and barrel section of the wheel. The spoke section may include a mating surface. The barrel section may be in contact with the spoke section at said mating surface.

In an exemplary aspect according to the above-referenced embodiment, the spoke section and the barrel section may each comprise a flange and a bead seat.

In another exemplary aspect according to the above-referenced embodiment, said flanges may be taller than said bead humps.

In another exemplary aspect according to the above-referenced embodiment, the flanges may be at least fourteen-point-five (14.5) mm tall relative to said bead seats and said bead humps may be at least zero-point-nine (0.9) mm tall relative to said bead seats.

In another exemplary aspect according to the above-referenced embodiment, the wheel may comprise a discontinuous carbon fiber material.

### BRIEF DESCRIPTION OF THE DRAWINGS

To further illustrate the advantages and features of the present disclosure, a more particular description of the invention will be rendered by reference to specific embodiments thereof which are illustrated in the attached drawings. It is appreciated that these drawings are not to be considered limiting in scope. The invention will be described and explained with additional specificity and detail through the use of the drawings in which:

FIG. 1 shows a cross-sectional view of one embodiment of the wheel of the present disclosure.

FIG. 2 shows a cross-sectional view of one embodiment of the wheel of the present disclosure.

FIG. 3 shows a cross-sectional view of one embodiment of the wheel of the present disclosure.

FIG. 4 shows a cross-sectional view of a bead hump of the spoke section of the wheel of the present disclosure.

FIG. 5 shows a cross-sectional view of a bead hump of the barrel section of the wheel of the present disclosure.

FIG. 6 shows a cross-sectional view of an embodiment of a portion of each of the spoke section and the barrel section of the wheel of the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

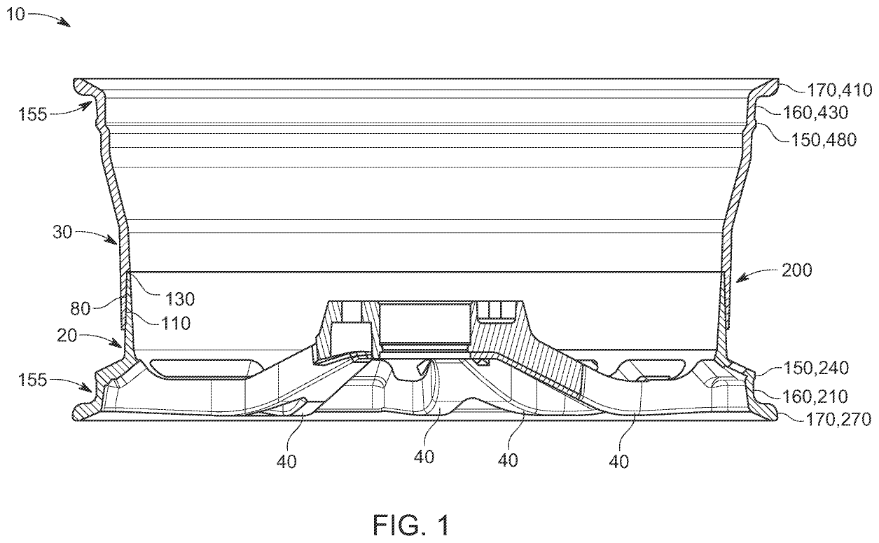

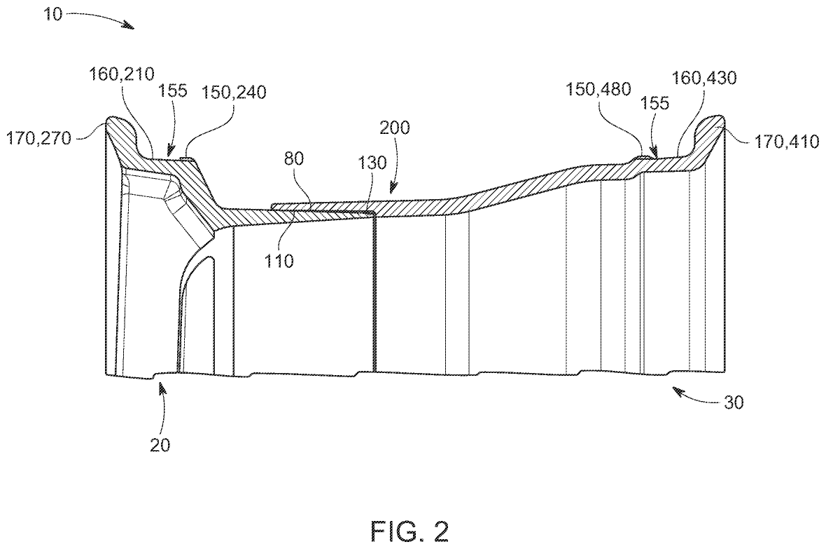

As shown in FIGS. 1-3, the present application provides an improved, two (2) piece wheel 10 which may be used on various automobiles, including but not limited to passenger cars and trucks. In some situations, it may be advantageous for a vehicle to improve tire grip, reduce slippage, and prevent creation of ruts by highly-pressurized tires by operating with tires inflated to a pressure that is lower than normal operating tire pressure. Reducing tire pressure can increase tire compression and thereby increase an amount of tire surface in contact with the ground surface below. Example situations include traverse of fine or loose surface material such as sand or gravel. The wheel 10 disclosed herein offers many advantageous features not found in prior art such as a lighter weight, stronger construction, and ability to function during operation at low tire pressure without a bolted bead lock ring as required by conventional off-road wheels.

Traditional bead lock wheels have locking rings that bolt onto a wheel and hold tire beads to the wheels to prevent separation when operated at low pressures. The locking ring may require use of multiple (e.g., up to thirty) or more bolts in order to attach the locking ring to the wheel. Such bolts sometimes attach to the wheel via threaded holes created on the wheel.

For wheels fabricated from metals, such as steel or aluminum, tapping threaded holes to accommodate bolts for a bead lock ring does not compromise integrity of the wheel to an unacceptable degree. However, tapping threaded holes in a carbon fiber component is likely to increase structural fatigue and compromise the component's structural integrity. This difficulty in adding traditional bead lock and bead lock ring posed a great challenge in carbon fiber bead lock design.

As a result, an alternate and novel bead lock design was generated by eliminating a ring and including an aggressive bead hump design to hold the tire bead. This novel bead hump geometry includes a steep angle and a specific height to maintain appropriate locking pressure.

Under pressurized operation, a tire may see most the load on the outer lip (where spoke is) during cornering. There is also a load on the inner lip (inside most of the vehicle), frequently less than the outer lip.

In some embodiments, the bead lock design can be more aggressive on the outer lip than on the inner lip (or, the tire lock geometry may even be non-existent on the inner, barrel section). Note the traditional bead lock design with a ring doesn't have any parts on the inner lip.

FIG. 1 shows a cross-sectional view of the fully assembled wheel 10. The surface profile of the wheel 10 includes one or more bead humps 150 with tire lock geometry 155 that serve to add security to a tire at low pressure by locking the bead of a tire into a bead seat 160 of the wheel 10 defined between a flange 170 of the wheel and the bead hump 150, thereby preventing slippage of the tire into the drop center 200 of the wheel (e.g., away from the wheel flange). As such, one of ordinary skill in the art can appreciate that although one design is shown in the figures included herewith, many different wheel designs and arrangements may be possible, and the scope of the present invention should not be limited by the design shown in the figures.

The spoke section 20 is the portion of the wheel farthest from the automobile. The spoke section 20 also has a mating surface 80 which is in contact with the barrel surface's mating surface 110 when the wheel 10 is assembled. The barrel section 30 is the portion of the wheel 10 closest to the automobile.

The spoke section 20 mates with the barrel section 30 at the mating surface 110. The shape, design, number, and length of the spokes 40 can be varied to increase the strength of the wheel 10. The mating surface 110 of the barrel section 30 may have a lip or stop 130 so that the leading edge of the spoke section's mating surface 80 rests against it once the two sections are fitted properly during assembly. This lip or stop 130 serves to provide that adequate overlap is created by the two opposing mating surfaces 80, 110 to provide for a secure assembly. The amount of overlap may vary depending upon the desired use of the wheel. In some embodiments, the amount of overlap may be between approximately 0.10 and 6.00 inches, approximately 0.50 and 5.00 inches, approximately 1.00 and 4.0 inches and approximately 1.50 and 3.0 inches. In one preferred embodiment, the amount of overlap is between approximately 1.50 and 2.00 inches.

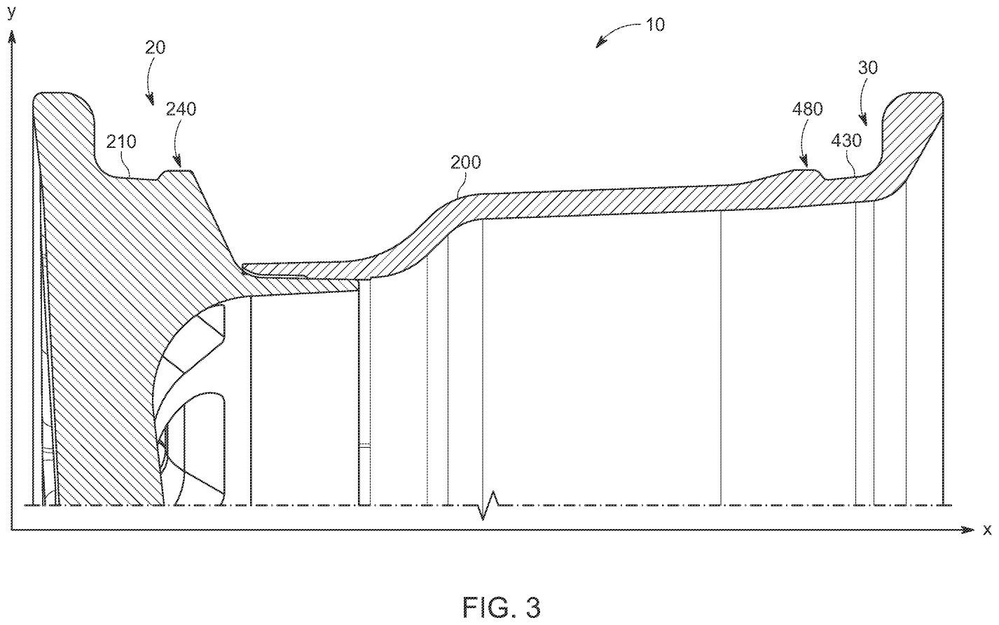

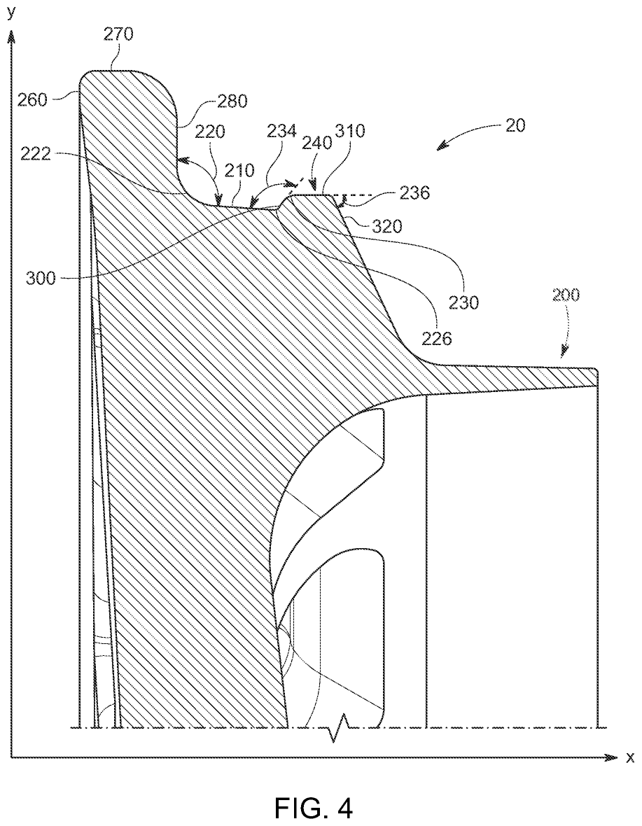

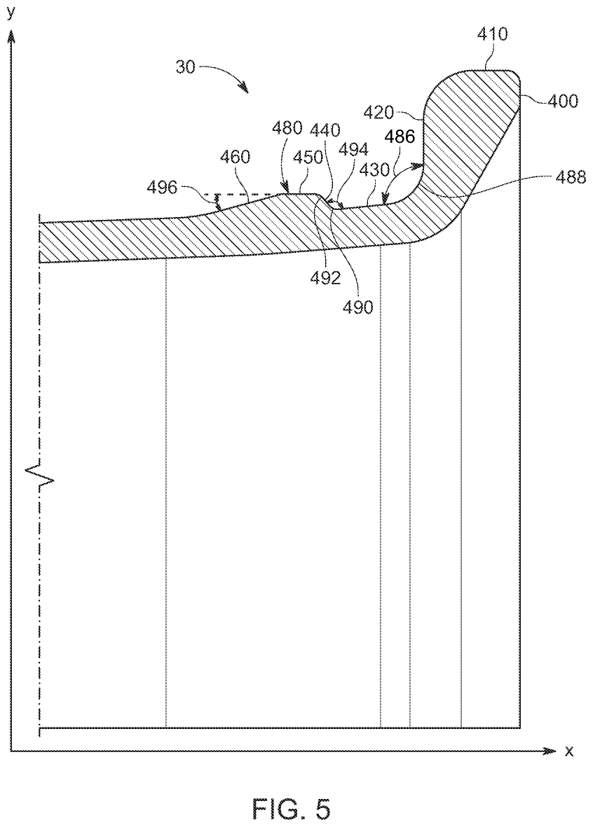

The bead hump 150 with tire lock geometry 155 is configured in a manner that maintains the integrity of the tire to wheel connection during periods of operation at low tire pressure, generally below 20 psi. One or more of the spoke section 20 or the barrel section 30 may include the bead hump 150 with tire lock geometry 155. As illustrated in FIGS. 3 and 4, the one or more bead humps 150 may include a spoke section bead hump 240 with the tire lock geometry 155. The one or more and a spoke section bead seat 210. As illustrated in FIGS. 3 and 5, the one or more bead humps 150 may include a barrel section bead hump 480 with the tire lock geometry 155. The tire lock geometry 155 of each of the spoke section 20 and the barrel section 30 may share many common elements, as further discussed below.

FIG. 4 shows a cross-sectional view of the spoke section 20 of the wheel. In particular, FIG. 4 shows the bead hump 240 with novel tire lock geometry 155. In one embodiment, the wheel 10 may implement a bead hump having such tire lock geometry on one or more of the spoke section 20 of the wheel and the barrel section 30 of the wheel. In another embodiment, the wheel 10 may implement a bead hump with tire lock geometry on both the spoke section 20 and barrel section 30 of the wheel, as shown in FIG. 3. In some embodiments, a bead hump with tire lock geometry may have an essentially constant cross-sectional geometric profile around an entire circumference of the wheel. Such cross-sectional geometric profile may comprise exclusively the tire lock geometry 155 described herein or may vary between other geometries and the tire lock geometry. In some embodiments, the bead hump's cross-sectional geometric profile may vary between a conventional bead hump profile and a bead hump profile having the tire lock geometry.

Upon reading of this disclosure, one of ordinary skill in the art will appreciate the novelty of a bead hump with tire lock geometry in a carbon fiber composite wheel. Indeed, terms such as “bead seat” and “bead hump” have particular meanings in the art and that are well understood by those of ordinary skill. Thus, to aid the reader and for efficiency of discussion, features of each of the spoke section 20 and barrel section 30 may be identified in the drawings by reference numbers and by name herein without the need to specifically delineate portions of the surfaces of the spoke section 20 and barrel section 30 where such features begin and end. For example, one of ordinary skill in the art will appreciate upon reading of this disclosure that the spoke section bead hump 240 refers to a portion of the surface of spoke section 20 between a spoke section bead seat 210 and drop center 200, and which is in contact with a portion of a tire's bead during operation, even without specific lines identifying points on the surface where such spoke section bead hump 240 begins and ends. Similarly, one of ordinary skill in the art will appreciate upon reading of this disclosure a barrel section bead hump 480 refers to a portion of the surface of barrel section 30 between a barrel section bead seat 430 and drop center 200, and which is in contact with a portion of a tire's bead during operation, even without specific lines identifying points on the surface where such barrel section bead hump 480 begins and ends.

The surface of the spoke section 20 has geometric variations defining bead hump 240, front flange 270, and the bead seat 210. It has been observed that the particular geometry of the bead hump 240 may create a sufficiently secure interaction between surfaces of the bead hump 240 and a portion of a tire bead, to reduce or eliminate tire bead slip enough to permit safe operation at low tire pressures. In one embodiment, this geometry is present on a composite wheel, such as a wheel fabricated with carbon fiber or similar composite materials. The front flange 270 is positioned between a front flange surface 260 on the spoke side of the wheel, and an interior front flange surface 280. The front flange surface 260 is adjacent to the front flange 270 on the spoke side of the wheel. The front flange 270 is positioned between the front flange surface 260 and interior flange surface 280. Geometry of the front flange 270 may vary, but in some embodiments may have a curved or chamfered portion with essentially constant radius or a varying radius around the rim lip's circumference. The interior front flange surface 280 is positioned between the front flange 270 and the bead seat 210.

In some embodiments, the bead seat 210 may be configured to contact a tire bead and may comprise a section of wheel surface that is between the front flange 270 and the bead hump 240. As is commonly done, when a tire is mated with the wheel 10, the bead of the tire rests in the bead seat 210. An exterior surface of the tire bead may be in contact with a surface of the front flange 270 and an interior surface of the tire bead may be in contact with a surface of the bead hump 240. In addition to their interwoven geometry, the bead hump 240 and bead seat 210 exist in connection with friction, adhesion, and any other force as common in the art to prevent tire slippage into the drop center 200 of the wheel.

The bead hump 240 may comprise a proximal surface 300 (e.g., relative to the front flange 270), a top surface 310, and a distal surface 320 (e.g., relative to the front flange 270). The proximal surface 300 may be defined between the bead seat 210 and the top surface 310. The proximal surface 300 may at least partially face the interior front flange surface 280. In certain optional embodiments, the proximal surface 300 may be parallel to the interior front flange surface 280. The interior front flange surface 280 may be parallel to the vertical axis (y-axis). In certain optional embodiments, the top surface 310 of the bead hump 240 may be essentially parallel to the horizontal axis (x-axis). In other optional embodiments, the top surface 310 of the bead hump 240 and the interior front flange surface 280 of the front flange 270 may be angled relative to each other at some angle other than ninety (90) degrees. The bead seat 210 may be angled relative to the interior front flange surface 280, for example, at a first angle 220. In certain optional embodiments, the first angle 220 may be between about ninety (90) degrees and about one-hundred (100) degrees. In other optional embodiments, the first angle 220 may be between about ninety-two (92) degrees and about ninety-eight (98) degrees. In further optional embodiments, the first angle 220 may be about ninety-five (95) degrees.

A first transition corner 222 may be defined between bead seat 210 and the interior front flange surface 280. The first transition corner 222 may be chamfered, having a first radius. The first radius may be about four-point-five (4.5) mm. In other optional embodiments, the first radius may be between about two (2) mm and about seven (7) mm. A second transition corner 226 may be defined between the bead seat 210 and the proximal surface 300 of the bead hump 240. The second transition corner 226 may be chamfered, having a second radius. The second radius may be about one (1) mm. In other optional embodiments, the second radius may be between about zero-point-two-five (0.25) mm and about two (2) mm. A third transition corner 230 may be defined between the top surface 310 and the proximal surface 300 of the bead hump 240. The third transition corner 230 may be chamfered, having a third radius. The third radius may be about zero-point-five (0.5) mm. In certain optional embodiments, the third radius may be about zero-point-three (0.3) mm. In other optional embodiments, the third radius may be between about zero-point-one (0.1) mm and about one (1) mm.

The proximal surface 300 of the bead hump 240 may be angled relative to the bead seat 210, for example, at a second angle 234. In certain optional embodiments, the second angle 234 may be between about eighty (80) degrees and about one-hundred (100) degrees. In other optional embodiments, the second angle 234 may be between about eighty-five (85) degrees and about ninety-five (95) degrees. In further optional embodiments, the second angle 234 may be about ninety (90) degrees. Alternatively, the proximal surface 300 may be angled at about nine-point-nine (9.9) degrees relative to the vertical axis (y-axis), or more broadly, between about five (5) and fifteen (15) degrees. Other angles may be possible to achieve the effect of maintaining the integrity of the wheel to tire coupling and preventing slippage of the tire into the drop center 200 of the wheel, even when the tire is at low pressure. In some embodiments, an angle of a top portion of the proximal surface 300 may be about fifteen-point-five (15.5) degrees relative to a plane parallel to the surface of the ground (x-axis). The proximal surface 300 may have a slightly curved profile and may extend at an approximately constant angle to the top surface 310 of the bead hump 240. In one embodiment, the proximal surface 300 measures about zero-point-nine (0.9) mm in length. In certain optional embodiments, the proximal surface 300 measures about one-point-nine (1.9) mm relative and perpendicular to the bead seat 210. In other optional embodiments, the proximal surface 300 measures less than about three (3) mm relative and perpendicular to the bead seat 210.

The top surface 310 of the bead hump 240 extends from the proximal surface 300 to the distal surface 320. The top surface 310 may have an essentially constant surface profile. The top surface 310 joins the distal surface 320 of the bead hump 240 after which the distal surface 320 descends toward the drop center 200 of the wheel. The bottom of the distal surface 320 descends beyond the bottom of the proximal surface 300. The distal surface 320 of the bead hump 240 may be angled relative to the top surface 310, for example, at a third angle 236 relative to the horizontal axis (x-axis). In certain optional embodiments, the third angle 236 may be between about fifty (50) degrees and about eighty (80) degrees. In other optional embodiments, the third angle 236 may be between about sixty (60) degrees and about seventy (70) degrees. In further optional embodiments, the third angle 236 may be about sixty-five (65) degrees.

The front flange 270 may be taller than the bead hump 240. The height of an element (e.g., how tall an element is) may be defined as extending radially from a center of the wheel relative to a reference point or reference element. In certain optional embodiments, the front flange 270 may be at least fourteen-point-five (14.5) mm tall relative to the bead seat 210. A distance between the interior front flange surface 280 and the proximal surface 300 of the bead hump 240 may be between about fourteen-point-five (14.5) mm and about fifteen-point-seven (15.7) mm.

FIG. 5 shows a cross-sectional view of the barrel section 30 of the wheel. The geometry of the barrel section 30 of the wheel may mirror that of the spoke section 20 of the wheel. The barrel section 30 of the wheel has a barrel side back flange 410 which is constructed in a similar fashion to the front flange 270, in that it has a back flange surface 400 on the barrel side of the wheel, and an interior flange surface 420, with the back flange 410 joining the back flange surface 400 and the interior flange surface 420.

The back flange surface 400 joins the back flange 410 on the barrel side of the wheel, after which the back flange 410 extends internally having an essentially constant profile. The back flange 410 joins the interior flange surface 420 which then sharply curves downwards and ultimately joins a barrel section bead seat 430. The back flange 410 is separated from a barrel section bead hump 480 by the barrel section bead seat 430.

The bead seat 430 may be configured to contact a tire bead and may comprise a section of wheel surface that is between the barrel side back flange 410 and the bead hump 480. As with the bead seat 210 of the spoke section, when a tire is mated with the wheel, the bead of the tire rests in the bead seat 430. An exterior surface of the tire bead may be in contact with a surface of back flange 410 and an interior surface of the tire bead may be in contact with a surface of the bead hump 480. In addition to their interwoven geometry, the bead hump 480 and bead seat 430 exist in connection with friction, adhesion, and any other force as common in the art to prevent tire slippage into the drop center 200 of the wheel. The barrel side bead hump 480 maintains similar geometry to the spoke side bead hump 240.

The bead hump 480 may comprise a proximal surface 440 (e.g., relative to the back flange 410), a top surface 450, and a distal surface 460 (e.g., relative to the back flange 410). The proximal surface 440 may be defined between the bead seat 430 and the top surface 450. The proximal surface 440 may at least partially face the interior flange surface 420. In certain optional embodiments, the proximal surface 440 may be parallel to the interior flange surface 420. The interior flange surface 420 may be parallel to the vertical axis (y-axis). In certain optional embodiments, the top surface 450 of the bead hump 480 may be parallel to the horizontal axis (x-axis). In other optional embodiments, the top surface 450 of the bead hump 480 and the interior flange surface 420 of the back flange 410 may be angled relative to each other at some angle other than ninety (90) degrees. The bead seat 430 may be angled relative to the interior flange surface 420, for example, at a first angle 486. In certain optional embodiments, the first angle 486 may be between about ninety (90) degrees and about one-hundred (100) degrees. In other optional embodiments, the first angle 486 may be between about ninety-two (92) degrees and about ninety-eight (98) degrees. In further optional embodiments, the first angle 486 may be about ninety-five (95) degrees.

A first transition corner 488 may be defined between bead seat 430 and the interior flange surface 420. The first transition corner 488 may be chamfered, having a first radius. The first radius may be about four-point-five (4.5) mm. In other optional embodiments, the first radius may be between about two (2) mm and about seven (7) mm. A second transition corner 490 may be defined between the bead seat 430 and the proximal surface 440 of the bead hump 480. The second transition corner 490 may be chamfered, having a second radius. The second radius may be about one (1) mm. In other optional embodiments, the second radius may be between about zero-point-two-five (0.25) mm and about two (2) mm. A third transition corner 492 may be defined between the top surface 450 and the proximal surface 440 of the bead hump 480. The third transition corner 492 may be chamfered, having a third radius. The third radius may be about zero-point-five (0.5) mm. In certain optional embodiments, the third radius may be about zero-point-three (0.3) mm. In other optional embodiments, the third radius may be between about zero-point-one (0.1) mm and about one (1) mm.

The proximal surface 440 of the bead hump 480 may be angled relative to the bead seat 430, for example, at a second angle 494. In certain optional embodiments, the second angle 494 may be between about eighty (80) degrees and about one-hundred (100) degrees. In other optional embodiments, the second angle 494 may be between about eighty-five (85) degrees and about ninety-five (95) degrees. In further optional embodiments, the second angle 494 may be about ninety (90) degrees. Alternatively, the proximal surface 440 may be angled at about nine-point-nine (9.9) degrees relative to the vertical axis (y-axis), or more broadly, between about five (5) and fifteen (15) degrees. Other angles may be possible to achieve the effect of maintaining the integrity of the wheel to tire coupling and preventing slippage of the tire into the drop center 200 of the wheel, even when the tire is at low pressure. In some embodiments, an angle between the bead seat 430 and the top of the proximal surface 440 may be about fifteen-point-five (15.5) degrees relative to a plane parallel to the surface of the ground (x-axis), although other angles may be possible in some embodiments. The proximal surface 440 is present with a slightly curved profile and extends at an approximately constant angle to the top surface 450 of the bead hump 480. In one embodiment, the proximal surface 440 measures about zero-point-nine (0.9) mm. In certain optional embodiments, the proximal surface 440 measures about one-point-nine (1.9) mm relative and perpendicular to the bead seat 430. In other optional embodiments, the proximal surface 440 measures less than about three (3) mm relative and perpendicular to the bead seat 430.

The top surface 450 of the bead hump 480 extends from the proximal surface 440 to the distal surface 460. The top surface 450 may have an essentially constant surface profile. The top surface 450 joins the distal surface 460 of the bead hump 480 after which the distal surface 460 descends toward the drop center 200 of the wheel. A bottom of the distal surface 460 may be defined as a portion that is essentially the same radial distance from a center of the wheel as that of a radially closest portion of a surface of the bead seat 430. The distal surface 460 of the bead hump 480 may be angled relative to the top surface 450, for example, at a third angle 496 relative to the horizontal axis (x-axis). In certain optional embodiments, the third angle 496 may be between about five (5) degrees and about thirty (30) degrees. In other optional embodiments, the third angle 496 may be between about twelve (12) degrees and about twenty-one (21) degrees. In further optional embodiments, the third angle 496 may be about fifteen-point-five (15.5) degrees. In still further optional embodiments, the third angle 496 may be greater than twenty (20) degrees.

The back flange 410 may be taller than the bead hump 480. In certain optional embodiments, the back flange 410 may be at least fourteen-point-five (14.5) mm tall relative to the bead seat 430. A distance between the interior flange surface 420 and the proximal surface 440 of the bead hump 480 may be between about fourteen-point-five (14.5) mm and about fifteen-point-seven (15.7) mm.

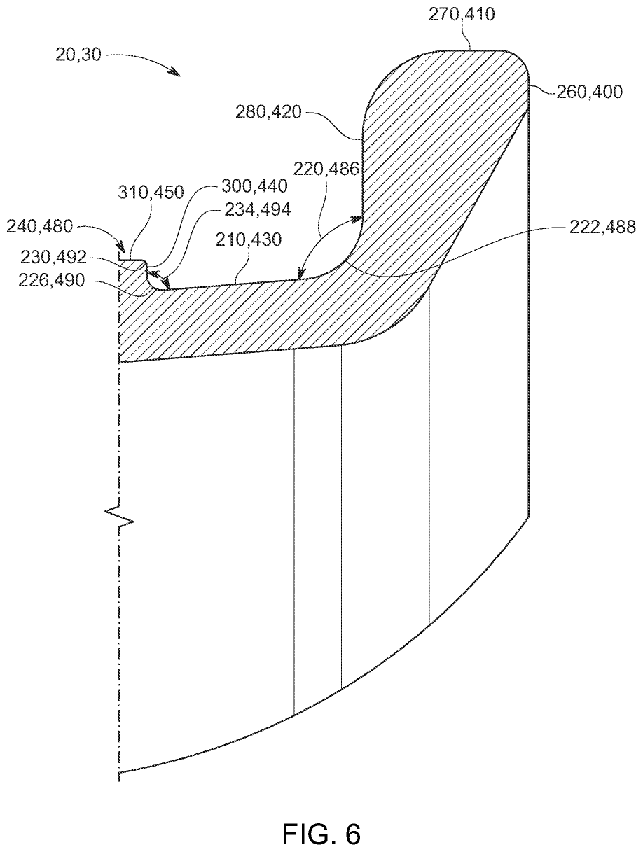

FIG. 6 shows a cross-sectional view of an embodiment of the spoke section 20 or the barrel section 30 of the wheel 10. FIG. 6 includes element numbering for both the spoke section 20 and the barrel section 30.

The wheel 10 may be made of many different materials, including composite materials such as discontinuous carbon fiber. The term “discontinuous carbon fiber” as used herein includes discontinuous fiber reinforced composites which may be discontinuous and aligned or discontinuous and randomly oriented. The discontinuous fibers consist essentially of carbon, ranging from graphite fibers to amorphous carbon fibers. Graphite fibers are fibers which consist essentially of carbon and have a predominant X-ray diffraction pattern characteristic of graphite. Amorphous carbon fibers are fibers which consist essentially of carbon and have an essentially amorphous X-ray diffraction pattern. Additionally, the term also includes other high strength, low density materials such as boron, fiber glass or the like or any of the forgoing in a mixture, such as 1-99% carbon fiber mixed with 99-1% fiber glass. For example, the wheel 10 may comprise one or more of the following composite materials a carbon fiber/fiber mixture, carbon fiber or fiber glass. Additionally, additives such as nanoparticles may be added to the composite materials before molding. Additionally, the wheel 10 disclosed herein may not be manufactured from a composite material but rather a metallic material such as aluminum, steel or other alloy. In an embodiment where the wheel 10 is manufactured from a metallic material, the components of the wheel may be forged, cast or machined. In addition to the composite materials and optionally the nanoparticles, a resin is used to bind the composite materials during molding. In one embodiment, the resin is selected from the group consisting of epoxies, polyurethane, rubber and polyester resins. In a further embodiment the resin is a vinyl ester/polyurethane resin or any other thermoset or thermoplastic polymeric resin or a metallic matrix. In other alternate embodiments, the resin may be selected from the group consisting of butadiene rubber, ethylene-propylene-diene rubber, melamine formaldehyde, natural rubber, phenol-formaldehyde, polyamide, polycarbonate, polypropylene and polytetrafluoroethylene.

The wheel 10 may be constructed using various methods of manufacture including compression molding. In one embodiment, the wheel 10 is constructed using a sheet molding compound (SMC) process or a bulk molding compound (BMC) process.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description Thus, although there have been described particular embodiments of a new and useful invention, it is not intended that such references be construed as limitations upon the scope of this disclosure except as set forth in the following claims.

What is claimed is:

1. A composite wheel for use at low tire pressure comprising:
a spoke section with a mating surface;
a barrel section in contact with the spoke section at said mating surface; and
a bead hump with tire lock geometry defined on at least the spoke section, the tire lock geometry including a flange with an interior flange surface and a bead seat positioned between the bead hump and the flange.

2. The wheel of claim 1 wherein the bead seat is angled relative to the interior flange surface of the flange at a first angle of about 92 degrees to about 98 degrees.

3. The wheel of claim 1 wherein a first transition corner is defined between the interior flange surface and the bead seat, the first transition corner chamfered with a radius of about 4.5 mm.

4. The wheel of claim 1 wherein the bead hump includes a proximal surface relative to the flange and at least partially facing the interior flange surface.

5. The wheel of claim 4 wherein a second transition corner is defined between the proximal surface of the bead hump and the bead seat, the second transition corner chamfered with a radius of about 1 mm.

6. The wheel of claim 4 wherein the proximal surface is angled relative to the bead seat at a second angle, the second angle being between about 85 degrees and about 95 degrees.

7. The wheel of claim 4 wherein a third transition corner is defined between the proximal surface of the bead hump and a top surface of the bead hump, the third transition corner chamfered with a radius between about 0.3 mm and about 0.5 mm.

8. The wheel of claim 1 wherein a top surface of the bead hump is perpendicular to the interior flange surface.

9. The wheel of claim 1 wherein said flange is taller than the bead hump.

10. The wheel of claim 1 wherein the flange is at least 14.5 mm tall relative to the bead seat.

11. The wheel of claim 1 wherein a top surface of the bead hump is at least 0.9 mm tall relative to the bead seat.

12. The wheel of claim 1 wherein a distal surface of the bead hump relative to the flange is angled relative to a top surface of the bead hump at a third angle greater than or equal to about 15.5 degrees.

13. The wheel of claim 1 wherein the wheel comprises a carbon fiber material.

14. The wheel of claim 1 wherein the wheel comprises a discontinuous carbon fiber material.

15. A composite wheel for use at low tire pressure comprising:
a spoke section with a mating surface;
a barrel section in contact with the spoke section at said mating surface; and
a bead hump with tire lock geometry on each of the spoke section and the barrel section of the wheel.

16. The wheel of claim 15 wherein the spoke section and the barrel section each comprises a flange and a bead seat.

17. The wheel of claim 16 wherein said flanges are taller than said bead humps.

18. The wheel of claim 16 wherein the flanges are at least 14.5 mm tall relative to said bead seats and said bead humps are at least 0.9 mm tall relative to said bead seats.

19. the wheel of claim 15 wherein the wheel comprises a carbon fiber material.

20. The wheel of claim 15 wherein the wheel comprises a discontinuous carbon fiber material.
